(19) United States
(12) Patent Application Publication
(10) Pub. No.: US 2020/0297166 A1
(43) Pub. Date: Sep. 24, 2020

(54) EGG BREAKER AND SEPARATOR DEVICE

(71) Applicant: Richard MAO, Lutherville, MD (US)

(72) Inventor: Richard MAO, Lutherville, MD (US)

(21) Appl. No.: 16/436,405

(22) Filed: Jun. 10, 2019

Related U.S. Application Data
(63) Continuation of application No. 16/416,950, filed on May 20, 2019, now abandoned.
(60) Provisional application No. 62/674,798, filed on May 22, 2018.

(51) Int. Cl. A47J 43/14

(52) U.S. Cl. CPC A47J 43/14

(57) ABSTRACT

A device is described for breaking an egg and separating an egg white from the yolk of the egg. The device includes a support base and a chute coupled to the support base. The chute has front end, a rear end, an enclosed section at the front end, and an open section at the rear end. An egg separation assembly is coupled to the enclosed section of the chute. The egg separation assembly has a curved panel and at least two vents proximate the curved panel. The device includes a breaker bar that spans across the chute and this positioned in a rearward direction relative to the egg separation assembly. The breaker bar is configured to crack a shell of the egg to release the yolk and the egg white onto the chute.

### CROSS-REFERENCE TO RELATED APPLICATIONS

The present application is a continuation of and claims the benefit of priority to U.S. application Ser. No. 16/416,950, filed May 20, 2019, which claims priority to and the benefit of U.S. Provisional Application No. 62/674,798, filed on May 22, 2018, the entire contents of each application listed in this paragraph are herein incorporated by reference.

### TECHNICAL FIELD

The present disclosure relates to a device for breaking an egg, and in particular, to a device for breaking and opening an egg, separating the yolk from the albumen, and directing the egg white into a fry pan or other surface, e.g. such as a dish.

### BACKGROUND

The concept of an egg breaker and egg white separator is well known. Indeed, this is a well-developed field and many prior art patent references are quite old. Many are designed for a commercial high-production setting. For example, U.S. Pat. No. 966,933 to George Lewis issued 9 Aug. 1910 shows an egg breaker and separator using a flat inclined chute 12 over which the broken egg must pass. U.S. Pat. No. 2,789,602 to Zagala issued 23 Apr. 1957 shows an eggshell breaker and separator in which a plurality of eggs may be positioned within a tubular container, the eggs successively broken and the yolk and white of the egg separated. Still others are designed for consumer use. For example, U.S. Pat. No. 2,589,408 to Le Boeuf issued 18 Mar. 1952 shows an egg breaker and separator in which a trigger constricts a collar about the egg and breaks it with teeth. U.S. Pat. No. 1,409,649 to Becker issued 14 Mar. 1922 shows an egg breaker and optional separator with a squeeze handle breaker attached to an egg receiver cup. U.S. Pat. No. 1,611,541 to McCrocklin issued Dec. 21, 1926 and 2,505,717 to Nastrom issued 10 Mar. 1947 both shows tools for breaking and separating eggs comprising a hand-operated scissor device in which squeezing the handles brings opposing halves of an egg cage together to constrain the egg, and continued squeezing urges a breaker blade into the shell. The yolk remains in the cage while the white drains through. U.S. Pat. No. 7,836,823 to Vassallo issued 23 Nov. 2010 shows a trap-like device with egg-piercing teeth. To break and open an egg, the egg is placed in a cavity, and the tool and egg are rapped sharply against a hard surface, such that the shell of the egg is pierced.

Although the above-described egg breaking and/or separating devices are well-intentioned, none are capable of breaking and opening, separating the yolk from the albumen, and directing the egg white into a fry pan or pot, all with a single hand in mere seconds with minimal effort and maximum reliability. Indeed, the prior art designs make no attempt to extricate the yolk from the egg white, the result usually being a broken yolk and/or poor separation. This is largely because the foregoing designs fail to take a systematic approach toward disassembling the complex structure of an egg. FIG. 1 is a diagrammatic view of the structure of a common egg. The yolk is supported within the albumin egg white and is suspended on opposing chalazae a pair of spring-like structures that project from the equatorial region of the vitelline membrane into the albumen. The chalazae act as balancers, maintaining the yolk in a steady position in the laid egg. The albumen is not of the same consistency throughout. This can be seen when emptying a fresh egg into a dish, the thinner, more watery, albumen spreads further than the thicker albumen which remains around the yolk. Within the unbroken egg, the same relationship occurs, the thicker albumen adhering to the vitelline membrane. To separate the yolk from the albumen, the yolk must be gently extricated from the albumen and isolated therefrom while the latter is drained, and then the yolk can be removed without breakage.

### SUMMARY

An embodiment of the disclosure is a device for breaking an egg. The device includes a support base and a chute coupled to the support base. The chute has front end, a rear end, an enclosed section at the front end, and an open section at the rear end. The device also includes an egg separation assembly coupled to the enclosed section of the chute. The egg separation assembly has a curved panel and at least two vents proximate the curved panel. The curved panel is configured to receive a yolk of the egg and at least two vents are configured to permit an egg white of the egg to pass therethrough. The device also includes a breaker bar that spans across the chute and this positioned in a rearward direction relative to the egg separation assembly. The breaker bar is configured to crack a shell of the egg to release the yolk and the egg white onto the chute.

### BRIEF DESCRIPTION OF THE DRAWINGS

The foregoing summary, as well as the following detailed description of illustrative embodiments of the present application, will be better understood when read in conjunction with the appended drawings. For the purposes of illustrating the present application, there is shown in the drawings illustrative embodiments of the disclosure. It should be understood, however, that the application is not limited to the precise arrangements and instrumentalities shown. In the drawings:

FIG. 1 is a sectional diagrammatic view of the composition of an egg;

FIG. 2 is a side view of the device for breaking and opening an egg according to an embodiment of the invention;

FIG. 3 is a side view of the device illustrated in FIG. 2, but showing an egg separation assembly, which is used to separate the egg yolk from the egg white and a ramp according to another embodiment of the present disclosure;

FIG. 4 is a side view of the same device as in FIGS. 2-3 illustrated in a folded configuration for storage;

FIG. 5A is a top perspective view of a breaker bar used in the device illustrated in FIGS. 2-4;

FIG. 5B illustrates side views of a breaker bar shown in FIG. 5A, with the break bar oriented in different positions;

FIG. 5C is a side perspective view of an egg approaching a breaker bar used in the device illustrated in FIGS. 2-4;

FIG. 6 is a rear perspective view of a portion of the device shown in FIGS. 2-4, illustrating a portion of the chute assembly;

FIG. 7 is a top rear perspective view of a portion of the device shown in FIGS. 2-4, illustrating a portion of the chute assembly;

FIG. 8 is a side view of a portion of the device shown in FIGS. 2-4, illustrating an egg separation assembly;

FIG. 9 is a top perspective of the slide plate and ramp of the device shown in FIGS. 2-4;

FIG. 10 is a rear view of an egg separation assembly of the device shown in FIGS.

FIG. 11 shows illustrates a base of the device according to another embodiment of the present disclosure.

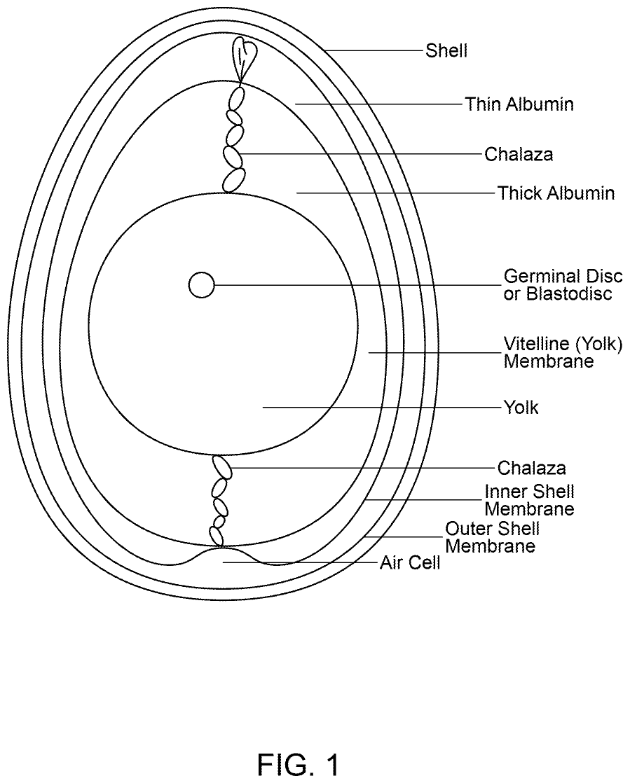

### DETAILED DESCRIPTION OF ILLUSTRATIVE EMBODIMENTS

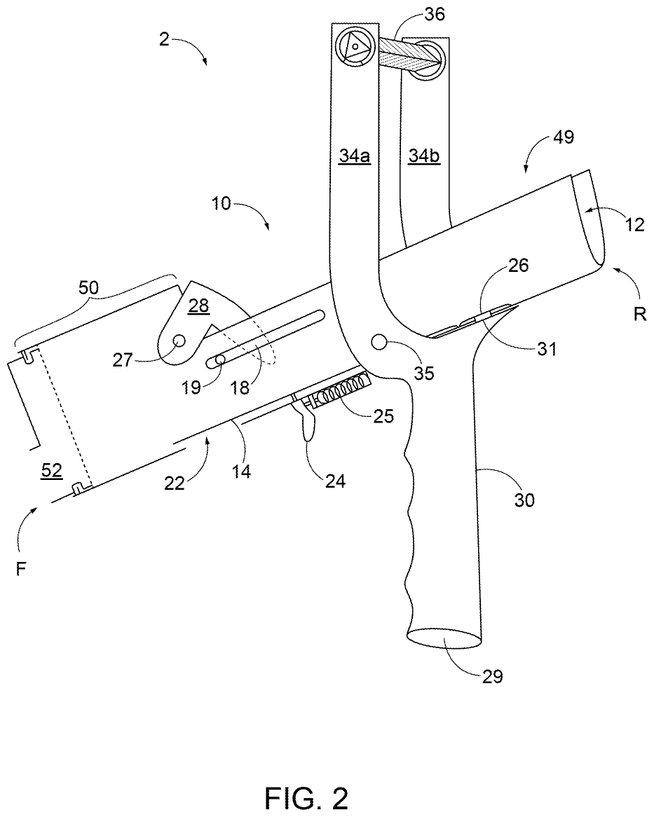

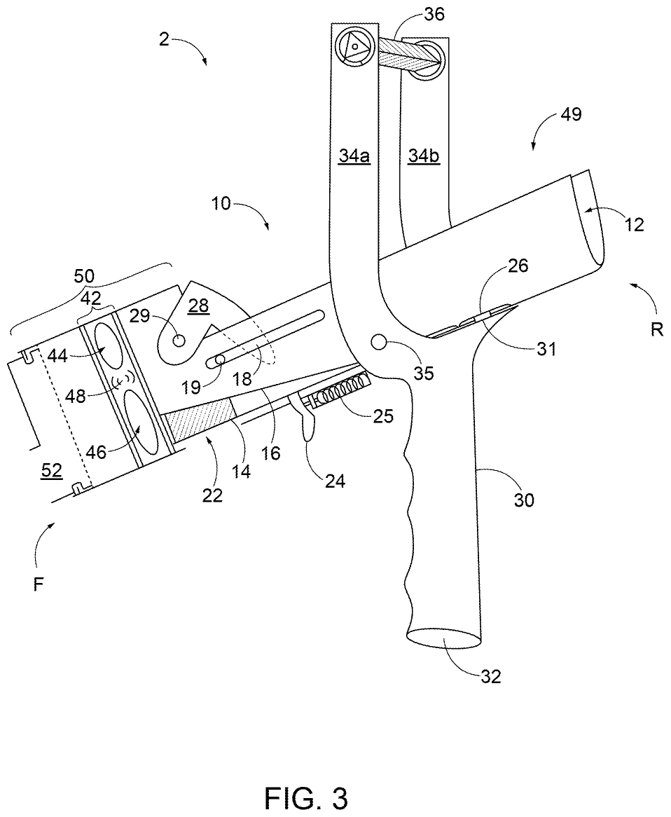

Embodiments of the present disclosure include a device for breaking an egg and optionally separating the egg white from the yolk. As shown in FIGS. 2 and 3, the device 2 includes a support base 30, a chute assembly 10 attached to the support base 30, a breaker bar 36, an egg separation assembly 42, and an optional nozzle 52. Optionally, the device 2 may also include a separate egg landing dish that is configured to receive the content of the egg exiting the device.

The chute assembly 10 may be removably attached to the support base 30 such that chute assembly 10 may be removed and separated from the support base 30 as needed. The chute assembly 10 has an elongated chute 12 along which the egg may travel by gravity. The chute 12, which may be inclined relative to horizontal, includes an open section 49 at a rear end R of the device 2 and an enclosed section 50 at the front F of the chute 12. As will be further discussed below, the cracked egg can travel along the chute 12 through the enclosed section 50 before exiting through the optional nozzle 52 to a receptacle (not number or shown). The receptacle can be a frying pan, pot, or dish, or anything else that receives the cracked egg. The open section 49 may be open approximately a distance of 5.0 inches measured from a rearward most point of the chute 12. In this regard, the measured distance is parallel to the direction of the egg travels along the chute. The enclosed section 50 may extend about 2.5 inches from the terminal end of the open section 49 to the a rearward most end of the nozzle. Again, this measured distance is parallel to the direction of the egg travels along the chute. The distances the open section 49 and the enclosed section 50 of the chute 12 may vary from the specific values discussed above. For instance, the distance of the open section may be less than 5.0 inches or greater than 5.0 inches as needed. Five inches is only exemplary. Likewise, the distance of the enclosed section 50 may be greater than 2.5 inches or less than 2.5 inches as needed. As illustrated in FIG. 2, the chute assembly 10 is attached to the support base 30 with an axle 35. However, the chute assembly 10 may be attached to support base 30 with other means, as described further below.

The support base 30 includes two opposing arms 34a and 34b that support the breaker bar 36. The breaker bar 36 is configured to facilitate breaking the shell of the egg. In the illustrated embodiment, the breaker bar 36 is positioned above the chute 12 so that the breaker bar spans across the chute 12. In the example shown, the breaker bar is positioned a distance between about 2 inches and 3 inches above the chute 12. In one example, the distance is about 2.5 inches. This particular distance is measured along a line that intersects the chute about two inches from a rearward end of a slide (discussed below). When the device 2 is resting on surface, this line is perpendicular to the surface upon which the device 2 rests. In some cases, the chute is inclined so that the line is angularly offset with respect to the surface of the chute. However, the breaker bar 36 may be positioned a distance that is less than three inches or is greater than three inches as needed. The breaker bar 36 may be rotatably mounted to arms 34a and 34b and straddles the arms 34a and 34b of the support base 30. In other examples, the breaker bar 36 may be removably mounted the arms 34a and 34b. In such an example, the breaker bar 36 does not specifically rotate. As illustrated, the arms 34a and 34b may be offset from the support base 30 a sufficient distance to allow the egg contents drop from the breaker bar 36 onto the chute. In one example, the offset distance is about one 1.5 inches.

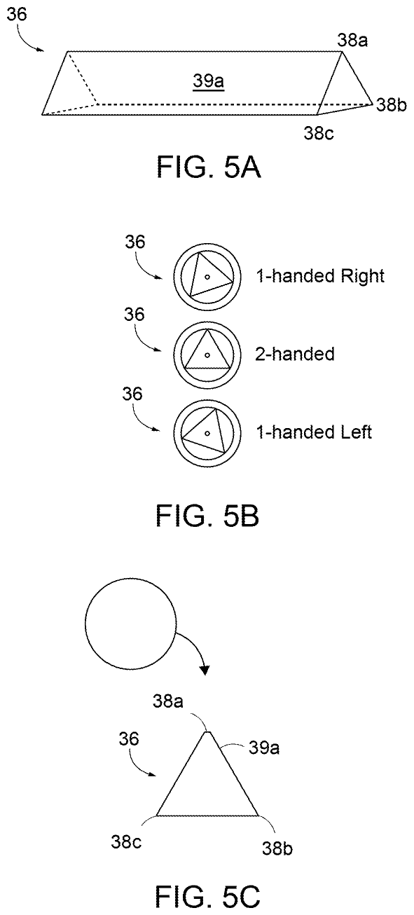

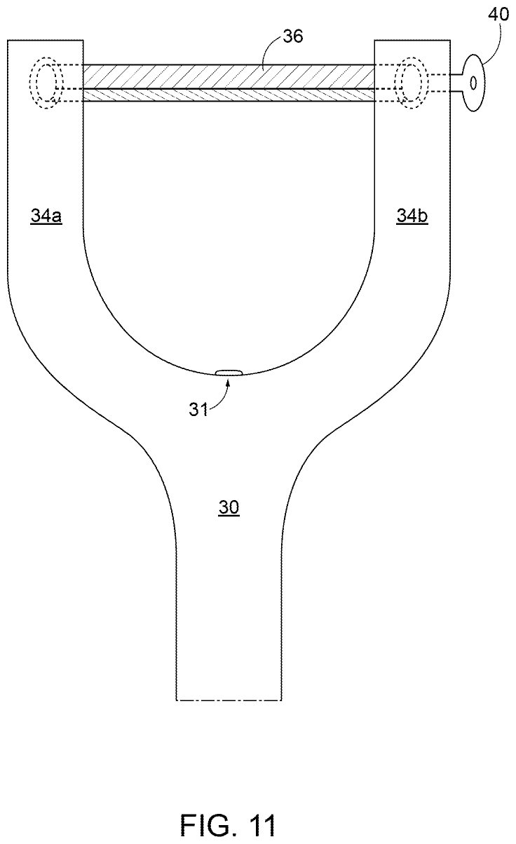

The breaker bar 36 may be movably mounted to the arms 34a and 34b to facilitate adjustment of the breaker bar 36. In one example, the breaker bar 36 is coupled to an actuator 40 (FIG. 11), such as a protruding knob or the like, which allows a use to rotate the breaker bar 36 as needed. The breaker bar 36 has at least two functional edges. As shown, however, the breaker bar has three preferable three functional edges. In the illustrated embodiment, the breaker bar 36 has a cross-sectional shape that approximates an equilateral triangle. Other cross-sectional shapes may be employed so long as the breaker bar has two or more functional edges. In this regard, each functional edge is manufactured to a have different degree of sharpness, as best shown in FIGS. 5A-5C. For example, the breaker bar 36 shown in FIGS. 5A-5C has three edges: a first edge A, which may be blunt; a second edge B, which may have a medium sharpness; and a third edge C that is sharper than the rest. The different functional edges are configured to facilitate cracking different egg shells because different eggs have different shell hardness. For example, store bought eggs have soft shells and would use a blunt edge. Farm-fresh eggs or brown eggs have very hard shells due to a higher content of calcium these chickens have more exposure to sunlight and thus vitamin D, and hence may require a more sharp edge. Accordingly, the breaker bar is movable, or rotatable, to orient one of the edges into a predetermined orientation.

In use, it is beneficial that a user approach the breaker bar 36 in a desired direction to create a specified angle with respect the desired functional edge of the breaker bar 36. Thus, the user can use the actuator 40 to orient the edge toward the approaching egg. In the illustrated embodiment, user can select the appropriate edge by rotation of breaker bar 36 via the actuator 40. In this example, the actuator 40 is a knob that protrudes from one of the arms. However, other mechanisms to change the position of the breaker bar 36 may be used. After the contents of the egg are spilled onto the open section 49 of chute 12, the yolk and white slide down the chute 12 by gravity feed alone.

The device 2 also includes a movable egg-shell catcher 28. The movable egg-shell catcher 28 is rotatably coupled the enclosed section 50 of the chute 12 at pivot point 27. The pivot point 27 may be defined by any coupling mechanism that allows the moveable egg-shell catcher to rotate or pivot with respect to point 27. The slide pin 19 can be used by the use to help position the moveable egg-shell catcher 28 in the correct position. In use, if the rear half of the egg shell should also fall from the hands of the user onto the chute it will be caught by a movable egg-shell catcher 28 that leaves enough bottom clearance to let the egg contents proceed beneath it along the chute.

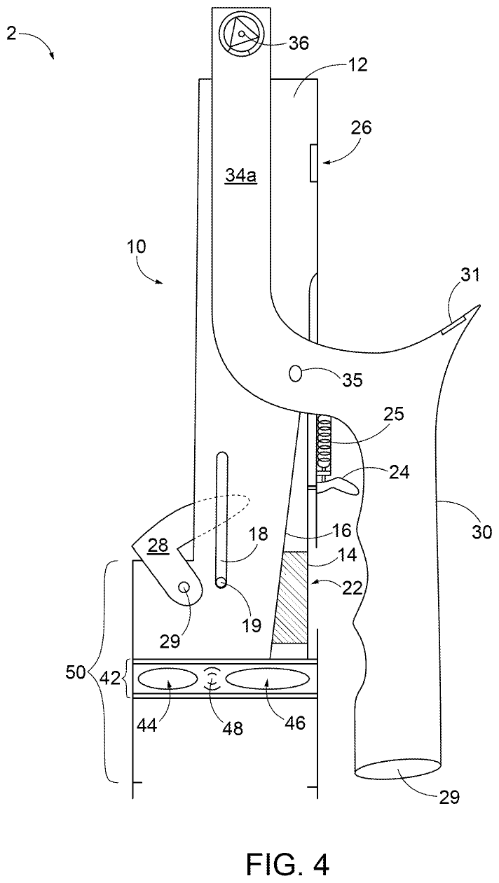

FIGS. 3 and 4 illustrate how the device 2 can transition between a folded configuration for storage (FIG. 4) and an active configuration (FIG. 3) for use. In the folded configuration, the device 2 has a footprint of about 3.5 inches by 3.5 inches. However, the footprint in the folded configuration may be more than 3.5 inches by 3.5 inches. In certain embodiments, the base 30 includes a magnet 29 that may be used to secure the device 2 to a metal stovetop or carried in a holster. The magnet 29 may be a like neodymium magnet.

FIGS. 5A-5C illustrate an embodiment of a breaker bar 36 used on the device 2. As shown, the breaker bar 36 includes an apex 38a and a rearward surface 39a that extends from the apex 38a in a direction generally toward the rear or back of the device. The apex 38a of each edge of the breaker bar 36 is directed slightly forward toward the front the device. However, the apex 38a lies on a plane that intersects a vertical plane at a specific angle. The specified angle may range from 0 degrees to 90 degrees. However, the angle may vary forward toward the front or rearward toward the back of the device, depending on the orientation of the breaker bar 36 following rotation via the actuator 40 (FIG. 11). For example, the angle may range from 0 degrees to +45 degrees forward or 0 to −45 degrees rearward relative to vertical plane. In a preferred example, the angle is between 10 and 20 degrees. In such an example, the angle is between +5 to +20 degrees forward of the vertical plane or −5 to −20 degrees rearward of the vertical plane. The rearward surface 39a of the breaker bar 36 guides the broken egg toward the chute 12. More specifically, the rearward surface 39a of the breaker bar 36 is angled to provide a platform onto which the yolk and albumen will land and gently diverts them down and back to the chute 12. However, to correctly break an egg shell one-handed, the direction of force should be directly down onto the breaker bar 36. Once the shell is cracked a sharp pull backwards is performed leaving the forward half of the shell behind allowing the back part of the egg to release the contents of the egg yolk and albumen together to fall upon rearward surface 39a of the breaker bar 36 before landing on the chute 12.

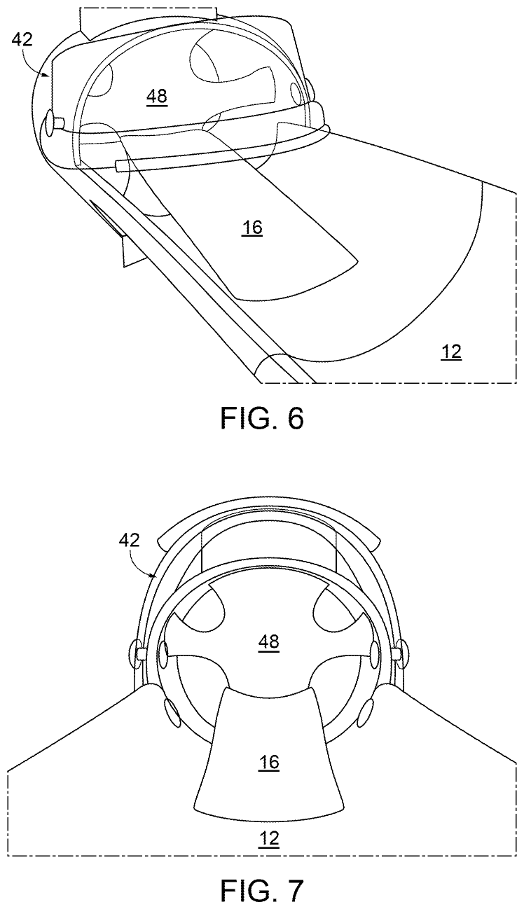

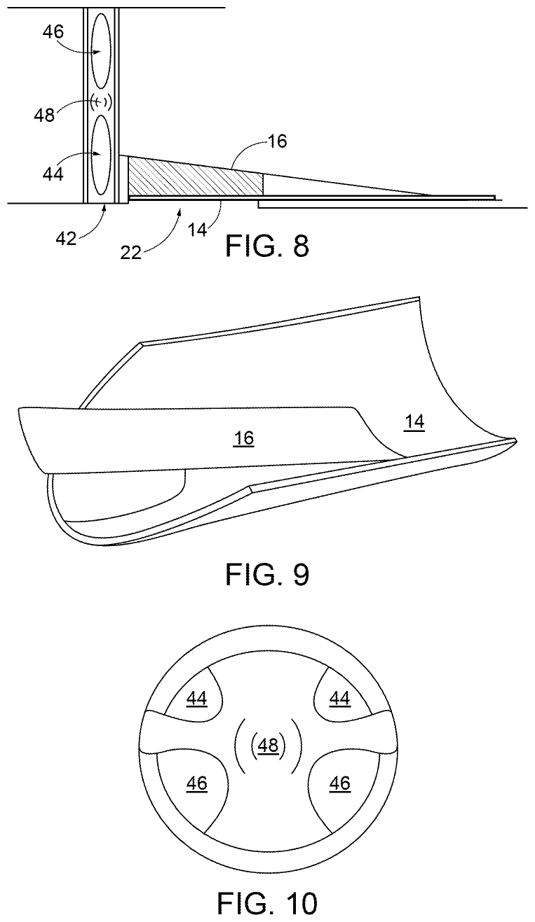

FIGS. 3 and 6-10 illustrates aspect of the device 2 which facilitates separation of the yolk from the egg white using ramp 16. As shown in the Figures, the device 2 includes a ramp 16 disposed on the chute 12 (FIG. 3) and gradually extends upward relative to the surface of the chute 12 itself. In addition, the ramp 16 has a width that is narrower than the width of the chute 12 so that a gap is formed between the sides of the ramp and the wall of the chute 12. In use, as perhaps best shown in FIG. 3, as the fluid contents of the egg are fed downward along the chute 12, the ramp 16 gradually elevates the yolk above the egg white and the egg white slides over the sides of the ramp, effectively separating the egg white from the yolk without breaking the yolk.

As shown in FIGS. 2 and 4, the device 2 may include a trigger mechanism 24 to selectively open and close a release hole 22. Sometimes the release hole 22 is referred to as a trap door 22. The trigger mechanism 24 can permit a user to perform all the functions with one hand, including the release of the egg yolk after separation is performed. The trigger mechanism 24 includes a spring 25 is coupled the trap door 22. The trigger 24 can be pulled, which, in turn, causes the trap door 22 to open. Release of the trigger 24 allows the trap door to snap closed. In one example, the trigger 24 may be coupled to a slide plate 14. The slide plate 14 includes tabs 19 that extend into a ride along a guide track 17 formed in the chute. The slide plate 14 thus slides along the guide track 19 when moved. The slide plate 14 covers a release hole (not numbered) defined in the chute 12. The release hole is positioned rearward of the egg separation assembly. The slide plate 14 may be retracted by actuation of the trigger 24, which may release the yolk through the release hole. Furthermore, the retraction of the slide plate 14 may cause the ramp 16 to elevate above the chute 12. This in turn ejects the separated yolk down through trap door 22 after the egg white has filtered through as will be described further below.

Turning to FIGS. 6-10, an egg separation assembly 42 removably attached to the enclosed section 50 of the chute 12. The egg separation assembly 42 may include an outer body and an inner curved panel that defines a concave center 48 and at least two vents. In one example, the egg separation assembly has at least two separate pairs of vents 44, 46. The two separate pairs of vents may be referred to as first pair of vents 44 and a second pair of vents 46. The concave center 48 is configured to seat the egg yolk when it reaches the end of the ramp 16. The yolk may be retained within the concave center 48. The first and second pairs of vents 44, 46 are designed to separate the yolk from the albumen without allowing the yolk to slip through should yolk fall from the ramp 16. As illustrated, the first pair of vents 44 may be smaller than the second pair of vents 46. For instance, the first pair vents 44 are sized for smaller eggs. Conversely, the second pair of vents 46 are sized for larger eggs, e.g. jumbo eggs. The egg separation assembly, though coupled to the chute 12, is rotatable relative to the chute 12 so that a user can direct which particular vents (smaller vs. larger vents) are positioned in the lower position. In this manner, the appropriate pair of vents 44, 46 can be rotated to the lower position to accommodate different egg types. More viscous egg whites command larger vents. It should be appreciated that egg white viscosity depends on the type of egg as well, e.g. store bought vs. farm fresh. Furthermore, the age of egg affects viscosity; fresher eggs can have more a more viscous albumen compare with an older or less fresh egg. Thus, the egg separation assembly creates added flexibility to separate a wide variety of egg types. Even so, the user could still hold the device vertically 90 degrees or even shake the device to separate very tenacious albumen.

Referring back to FIGS. 2-3, the device 2 may include a removable nozzle 52. The removable nozzle 52 may be used to slow exit of the egg or egg white from the device 2. This functionality may be important if the user plans to cook more than one egg. The nozzle will allow the use to better direct where you want the egg to end up in the pan. The nozzle 52 can also include a removable cap to close off the end of the nozzle. The cap allows the use to transport the device to another location, for example, such as to a camp fire if you are out camping, etc.

Referring now to FIGS. 2, 3 and 11, another embodiment of the device is illustrated with one or more attachment devices to secure the chute assembly 10 in place. More specifically, the support base 30 may include an attachment device 31 positioned on support base 30 inside between the arms 34a, 34b. The attachment device 31 may be magnet, tab, projection, or another feature. The chute assembly 10 may include another attachment device 26 configured to attach to the attachment device 31 on the support base 30. The attachment devices 26 and 31 may be opposing magnets, mechanical couplers, or any other mechanism that will removably couple the chute assembly 10 to the support base 30. For instance, in one example, opposing magnets or metal inserts may be spaced radially along the open section 49 of chute 12 to releasably attach the chute assembly 10 to support base 30. This way, the device 2 may be securely seated and fixed in the proper position for usage with the nozzle 52 directed into a pot or pan.

The base, chute and arms may be formed from any polymeric material. In one example, the base, chute and arms may be formed from polyvinyl chloride (PVC). However, any suitable thermoplastic or thermoset polymer or copolymer may be used.

It should now be apparent that a key feature of the above-described device helps the user to break and open a single egg. It can then separate an egg yolk from its egg white while keeping it intact. The entire operation can reasonably be completed with one hand, in seconds, with no mess or fuss.

Embodiments of the present disclosure include a device for breaking and optionally separating the egg yolk from the egg white. An aspect of the device is to provide an egg breaking and separating device as described above that operates with minimal effort but has reliable and consistent operation. Another aspect of the present disclosure is a device that gently extricates the yolk from the albumen and isolates the yolk while the albumin is drained. In this regard, the yolk is ejected into a receptacle via gravity. In yet another aspect of the present disclosure, the device may be used in either a consumer and or commercial setting, for example to process a large number of eggs in a reasonable short period of time.

The foregoing among other objectives and other objects are accomplished with a device for breaking and opening an egg, gravity-separation of the yolk from the albumen, and pouring the egg white into a fry pan and/or pot or dish. The hand-operated device generally comprises a pistol-grip base magnetically attached to a separation chute. The base supports an adjustable breaker bar upon which an individual can manually crack an egg. The platform at the end of the chute catches the egg and then passes it down the chute. As the egg travels down the chute either 1) the whole egg yolk and white can pass through the device and slide right out into the desired receptacle, or 2) the whole egg passes through an egg separation assembly where the yolk and egg white are separated from one another while integrity of the yolk is maintained. In this case, the egg white alone continues on through the chute enclosure and drops into the receptacle, while the yolk is retained by the egg separation assembly. The yolk can be ejected from the device into another receptacle through a trap door that is opened by a trigger. Operation of the device can reasonably be accomplished with one hand, in seconds, with no mess or fuss. In some aspects, magnets hold the chute to the support base and can also hold the support base to the edge of the stove top, or to an optional stand or holster.

Having now fully set forth the preferred embodiments and certain modifications of the concept underlying the present invention, various other embodiments as well as certain variations and modifications of the embodiments herein shown and described will obviously occur to those skilled in the art upon becoming familiar with the underlying concept. It is to be understood, therefore, that the invention may be practiced otherwise than as specifically set forth in the appended claims.

What is claimed:

1. A device configured to break and open an egg, the device comprising:
a support base;
a chute coupled to the support base, the chute having front end, a rear end, an enclosed section at the front end, and an open section at the rear end;
an egg separation assembly coupled to the enclosed section of the chute, the egg separation assembly having a curved panel and at least two vents proximate the curved panel, wherein the curved panel is configured to receive a yolk of the egg and the at least two vents are configured to permit an egg white of the egg to pass therethrough; and
a breaker bar that spans across the chute and this positioned in a rearward direction relative to the egg separation assembly, wherein the breaker bar is configured to crack a shell of the egg to release the yolk and the egg white onto the chute.

2. The device according to claim 1, wherein the breaker bar has at least one edge.

3. The device according to claim 1, wherein the breaker bar has at least two edges with each edge having a different sharpness.

4. The device according to claim 1, wherein the breaker bar has three edges with each edge having a different sharpness.

5. The device according to claim 1, wherein the breaker bar is movable to orient one of the at least two edges into a predetermined orientation.

6. The device according to claim 5, further comprising an actuator coupled to the breaker bar, wherein the actuator is configured cause the breaker bar to orient one of the at least two edges into the predetermined orientation.

7. The device according to claim 1, the curved panel defines a concave center, wherein the concave center is configured to retain the yolk.

8. The device according to claim 1, wherein the at least two vents is a first pair of vents and a second pair of vents, wherein the first pair of vents are larger than the second pair of vents.

9. The device of claim 1, wherein the support base includes two opposing arms, and the breaker bar is positioned at top portion of the two opposing arms so that the breaker bar spans across the chute.

10. The device according to claim 1, where the chute includes a release hole at the enclosed section for permitting the yolk to pass therethrough.

11. The device according to claim 10, further comprising:
a slide plate covering the release hole formed in the chute; and
a trigger mechanism coupled to the slide plate, the trigger mechanism configured to cause the slide plate to move into a position where it no longer covers the release hole so that the yolk is releasable through the release hole.

12. The device according to claim 11, wherein the trigger mechanism includes a spring coupled to the slide plate.

13. The device according to claim 1, wherein the support base includes an upper portion that supports the chute and a lower portion that includes magnet, wherein the magnet is configured to maintain the device in position on a stove top or metallic surface.

14. The device according to claim 1, further comprising a nozzle coupled to enclosed section of the chute that permit a part or all of the egg to pass therethrough.
